(19) United States
(12) Patent Application Publication
(10) Pub. No.: US 2015/0086824 A1
(43) Pub. Date: Mar. 26, 2015

(54) UNDRAINABLE BATTERY POWER SYSTEM OF INTERLOCKING LEGO-LIKE INTERCONNECTABLE PLUGGABLE INTERCHANGEABLE INTER-RECHARGEABLE BATTERIES

(71) Applicants: Oswaldo Nicolas BURGA, Lima (PE); Carlos Alberto IBANEZ VIGNOLO, Lima (PE)

(72) Inventors: Oswaldo Nicolas BURGA, Lima (PE); Carlos Alberto IBANEZ VIGNOLO, Lima (PE)

(21) Appl. No.: 14/466,979

(22) Filed: Aug. 23, 2014

Related U.S. Application Data
(62) Division of application No. 13/197,115, filed on Aug. 3, 2011, now Pat. No. 8,851,006.

(51) Int. Cl. H01M 2/20; H01M 2/10

(52) U.S. Cl. CPC H01M 2/204; H01M 2/206; H01M 2/1022; H01M 2/1072
USPC 429/99; 429/100; 429/121

(57) ABSTRACT

“Undrainable battery power system of interlocking lego-like interconnectable pluggable interchangeable inter-rechargeable batteries as well as connectible to a energizable product (e.g. machine, engines, apparatus, devices, gadgets, widgets and the like)”. The present invention relates to a system of one or more inter-pluggable batteries, each one having one or more settings/projections/stud poles, and; one or more housings and/or frames namely holes and/or encasings, enabling the said batteries to heap up on top of each other and get linked and plugged by fitting into the other rear end hole(s) or housing(s) or encasing(s) of another same referred pluggable battery forming stacks like lego bricks by being tightly-, securely- or loosely-attached, plugged, fastened or adjusted to one another, as well as the said batteries permitting the conduction in series and/or parallel of energy from one battery into the other battery in a pole-into-hole way and into an energizable product (e.g. machine, engines, apparatus, devices, gadgets, widgets and the like). Said battery system having energy time released capacity further comprise: a) back-up energy accumulating capacity as an energy drain retardant for one or more interchangeable rechargeable or analogous batteries may feed energy to the decaying battery, and; b) by interchanging the said batteries.

### RELATED APPLICATION

This section contains a complete lexicographically, contextually, procedurally and holistically [(what is meant to be said) specification as a divisional filing from parent U.S. patent application Ser. No. 13/197,115, filed Aug. 3, 2011, the disclosure of which concerning independent claim “Battery” invention II is hereby applied.

### GLOSSARY

In the present invention, the terms on the title: interlocking, lego-like, interconnectable and pluggable, are meant to include the meaning of the terms: inter-engageable, inter-linkable, inter-attachable, inter-stackable, inter-adjustable and inter-framable.

All this words are to be use lexicographically, contextually, procedurally and holistically in an indistinct manner.

### TECHNICAL FIELD

The disclosed embodiment relates generally to batteries, more particularly with interconnectable interchangeable and rechargeable batteries.

### BACKGROUND

In the prior art and as every PHOSITA (person having ordinary skill in the art) currently knows, batteries always need an outer casing to be united, and to get set and be kept in place in order to maintain energy flowing property.

In one example, flashlights include a housing, namely a case to keep batteries in place.

In another example, portable devices like the smartphones need a casing to keep the battery in place.

However, this casings increase cost production and brings ecological concerns.

Accordingly, there is a need for more efficient ways of keeping the batteries in place without using a case or special housing.

For instance, in Furth's U.S. Pat. No. 6,942,359 the battery ends are merely in loose contact.

Furthermore, energizable products always stop working because in spite the fact that batteries with less weight, less volume, more power and duration currently exist on the market, batteries do get drained and need to be recharge frequently.

Atomic batteries are not the solution to this draining problem because they are very dangerous.

### SUMMARY

The above deficiencies and other problems associated with the use of batteries in devices are reduced or eliminated by the present disclosed linkable interchangeable interstackable undrainable continuously rechargeable battery system.

The present invention refers to batteries, and in particular is a system and product namely a lego-like heapable pole-into-hole stackable linkable battery. Furthermore the present invented battery system may be rechargeable.

In the present disclosure the batteries are pluggable and interchangeable where the front end of the battery may be plugged so forth to the rear end into by studs projections settings located in the front end of said batteries, thus permitting to fit loosely, snugly or having a tightly sealed engagement between said batteries summing/adding energy in serial circuit or parallel.

In a preferred the batteries of the present invention have the capacity of linking one another as they have studs to fit into housing and set together like lego bricks.

The batteries of the present invention have the capacity of linking to each other.

The batteries may be of current kind known (e.g. rechargeable capacity).

### BRIEF DESCRIPTION OF THE DRAWING

For a better understanding of the aforementioned embodiment, reference should be made to the Description of the Embodiment below, in conjunction with the following drawing in which like reference numerals refer to corresponding parts throughout the FIGURE.

FIG. 8C is an inner view of a motorized energizable product e.g. a hydrodynamic surfing bib (patent application Ser. No. 13/197,115) where the linkable batteries (25a, 25b) can be seen interconnected to a propulsion engine 23.

### DESCRIPTION OF THE EMBODIMENT

A system of one or more interlocking lego-like interconnectable inter-engageable inter-linkable inter-attachable inter-stackable inter-pluggable inter-adjustable inter-framable inter-rechargeable batteries and feasible of being connected to all kind of energizable products such as engines, devices, machines, machinery, apparatuses, widgets, gadgets and any analogous.

The additional novelty is that, this interlocking batteries can be connected and recharge one another when one or more of said linkable batteries become drained.

### GENERAL DESCRIPTION

Reference will now be made in detail to the embodiment, example of which is illustrated in the accompanying drawing. In the following detailed description, specific details are set forth in order to provide a thorough understanding of the present invention. However, it will be apparent to one of ordinary skill in the art that the present invention may be practiced without these specific details. In other instances, further depictions have not been described in detail so as to not unnecessarily obscure aspects of the embodiment.

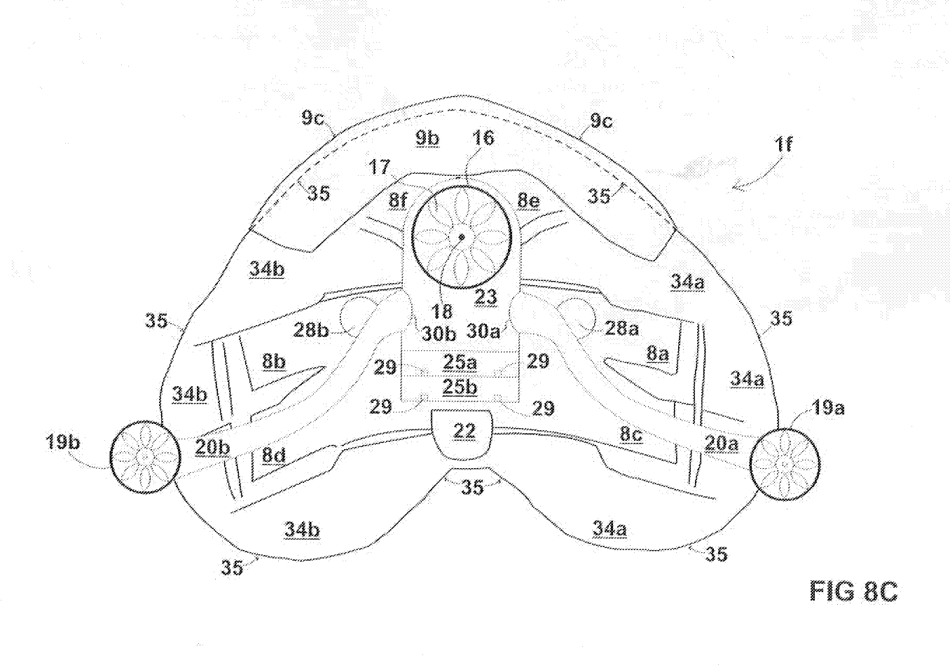

According to the present invention, as an illustrative example a motorization can be seen 23, said motorization is energized FIG. 8C with setting batteries 25a, 25b 29 capable of being linked interlocked interconnected engaged linked attached stacked plugged adjusted frame one to another in heaps like lego bricks, and are solar energizable.

In FIG. 8C at the center of the drawing 1f is mono-block 23 containing a per se known engine of electric type, against which batteries 25a and 25b are leaned against each other and linked together, by means of settings 29 and are also interconnected to energizable products (e.g. machine, engines, apparatus, devices, gadgets, widgets and the like).

In the present disclosure, the batteries are pluggable as it can be seen in FIG. 8C where the front end of battery 25b is plugged so forth to the rear end into the housings 29 of battery 25a by two studs settings located in the front end of said batteries, thus permitting a loose, snug or tight sealed engagement between said batteries summing/adding energy in serial circuit or parallel.

The present batteries in general as said may be typically rechargeable or the non rechargeable type.

The FIGURE is a preferential model—not the only one—and illustrative of the disclosed invention. Therefore, this does not mean that this is the only linkable battery system possible to be made, as there is a number of applicable geometric forms, alterations, combinations and modifications possible to be achieved, and which are the spirit and intention of the present invention. Several combinations of the elements claimed can be made within the range of the present invention.

The present invention is considered to be only an illustration of the principles of the invention. Besides, since it is highly probable that the experts in this matter will come up with numerous modifications and changes, it is not desired to limited the present invention to the exact construction and operation shown and described, therefore, every possible modification and equivalents can be resorted to, falling into the field of the present invention claimed.

1. An undrainable batter power system comprising one or more interlocking lego-like interconnectable inter-engageable inter-linkable inter-attachable inter-stackable inter-pluggable inter-adjustable inter-framable inter-rechargeable batteries, each one having one or more settings/projections/stud poles, and; one or more housings and/or frames and/or holes and/or encasings, enabling the said batteries to heap up on top of each other and get linked and plugged by fitting into the other rear end hole(s) or housing(s) or encasing(s) of another same referred pluggable battery forming stacks like lego bricks by being tightly-, securely- or loosely-attached, plugged, fastened or adjusted to one another, as well as the said batter permitting the conduction in series and/or parallel of energy from one battery into the other battery in a pole-into-hole way and into an energizable product (e.g. machine, engines, apparatus, devices, gadgets, widgets and the like). Said battery system having energy time released capacity further compromise: a) back-up energy accumulating capacity as an energy drain retardant for one or more interchangeable rechargeable or analogous batteries may feed energy to the decaying battery, and; b) by interchanging the said batteries.

2. An energizable product (e.g. machine, engines, apparatus, devices, gadgets, widgets and the like) having, either: housings/frames/holes, and/or, projections/plugs/cleats to permit being interconnected with the linkable battery of claim 1.

3. The Lego-like linkable battery of claim 1 comprising various shapes:
A) block square, and/or;
B) round, and/or;
C) cylindrical, and/or;
D) conical, and/or;
E) truncated pyramid, and/or;
F) Any kind of shape.
